(19) United States
(12) Patent Application Publication
(10) Pub. No.: US 2025/0364669 A1
(43) Pub. Date: Nov. 27, 2025

(54) BATTERY HOUSING AND BATTERY SYSTEM COMPRISING THE SAME FOR A MOTOR VEHICLE

(71) Applicant: Webasto SE, Stockdorf (DE)

(72) Inventors: Salome Ladeira, Stockdorf (DE); Alexander Dörr, Stockdorf (DE); Gichan Park, Stockdorf (DE); Steffen Lorenz, Stockdorf (DE); Hyokyu Lee, Stockdorf (DE)

(21) Appl. No.: 18/872,468

(22) PCT Filed: Jun. 6, 2023
(86) PCT No.: PCT/EP2023/065071

§ 371 Date: Dec. 6, 2024

(30) Foreign Application Priority Data
Jun. 7, 2022 (DE) 102022205778.3

(51) Int. Cl. H01M 50/333; H01M 10/42; H01M 10/48; H01M 50/209; H01M 50/249; H01M 50/30; H01M 50/342; H01M 50/375

(52) U.S. Cl. CPC H01M 50/333; H01M 10/425; H01M 10/486; H01M 50/209; H01M 50/249; H01M 50/3425; H01M 50/375; H01M 50/394; H01M 2010/4271; H01M 2010/4278; H01M 2200/20; H01M 2220/20

(57) ABSTRACT

A battery housing for receiving at least one battery module, which has a multiplicity of battery cells and comprises: a housing body which encloses an interior which is configured to receive the battery module, wherein the housing body has a vent opening which connects the interior to an environment of the housing body, a pressure safety valve which is arranged in the vent opening and is configured to close the latter, so that the interior is encapsulated in a gas-tight and liquid-tight manner with respect to the environment by the pressure safety valve in a normal operating state of the battery module, wherein the pressure safety valve is designed to open in the case of a pressure exceeding a threshold value in the interior of the housing body and thereby to allow a medium to be expelled from the interior into the environment, and a temperature sensor for detecting a temperature of the medium flowing past, wherein the temperature sensor is arranged on the housing body or the pressure safety valve in or close to the vent opening.

### CROSS-REFERENCE TO RELATED APPLICATIONS

This application is a 35 U.S.C. § 371 National Stage Entry of International Application No. PCT/EP2023/065071 filed Jun. 6, 2023, which claims the priority benefit of German Patent Application Serial Number DE 10 2022 205 778.3 filed Jun. 7, 2022, all of which are incorporated herein by reference in their entirety for all purposes.

### TECHNICAL FIELD

Various aspects relate to a battery housing and a battery system comprising the same, in particular a battery system for motor vehicles. They relate in particular to battery systems which have a battery management system which is capable of detecting a thermal runaway.

### TECHNICAL BACKGROUND

Such battery systems are used as traction batteries in particular in electric and hybrid motor vehicles and in vehicles with drives based on fuel cells. For reasons of sustainability and climate protection, but also on account of technical and economic advantages, such battery systems are currently the subject of intensive research and development. They comprise, for example, a battery pack with a battery housing into which, in addition to a battery management system, a high-voltage module and a cooling system etc., one or more battery modules are inserted. The latter contain in each case a multiplicity of battery cells which are joined together and connected in series and/or in parallel. In the motor vehicle sector, these—without restricting the aspects of the invention to be described below—are currently generally lithium-ion rechargeable batteries.

Under certain conditions, however, in the case of such lithium-ion rechargeable batteries—but also in the case of other battery types—a thermal runaway can occur. During the thermal runaway, oxygen is released by the chemical decomposition, for example, of an oxide of the cathode material. This can react chemically with further cell constituents, for example with the electrolyte used in the cell. The consequence can be an exothermic reaction which speeds up itself and can hardly be sustained from the outside and releases further thermal energy. A thermal, explosion-like destruction of the relevant battery cell may result therefrom. If permissible operating temperatures of, for example, −30° C. or −20° C. up to +60° C. are specified depending on the type of such lithium-ion rechargeable batteries, the formation of gas can begin, for example, already at a so-called onset temperature of +90° C. and the runaway can be, depending in particular on the state of charge of the cell, between, for example, +90° C. and +175° C. for the NMC cells frequently used in motor vehicles. The specified temperatures vary greatly depending on the type of cells. The operating age may also play a role. The causes may be an overcharging of the battery cell or an excessively high discharge rate. Furthermore, the mere exposure of the cell to high temperatures may lead to overheating of the cell, furthermore a short circuit via one of the separators, for example on account of contamination, or damage such as, for example, by a breakdown.

Once the thermal runaway has started, it can spread rapidly from one cell to the next and lead to explosions and a high risk of fire. The gases formed may ultimately lead to temperatures of +500° C. and more. By-products of a thermal runaway may be formed by considerable amounts of flammable hydrogen and other toxic, in particular organofluorine gases. The formation of gas furthermore gives rise to a pressure increase in the battery module, which pressure increase is instantaneously transferred to the interior of the battery housing of the battery pack. The battery housing is generally encapsulated in a gas-tight manner with respect to an environment of the battery system. Often, an emergency venting system may be provided for degassing in the battery housing. For this purpose, a pressure safety valve may be provided which is designed as a single-use valve by means of a burst disk. The burst disk may, for example, burst as a predetermined breaking point in the case of a predefined overpressure by means of a notch which is formed therein, and release a vent opening through which the hot gases may escape.

If a thermal runaway takes place in a battery cell, the event can be transferred rapidly to the adjacent cells in the battery module. In order therefore to be able to initiate fail-safe measures of any type in a timely manner, an early detection of a temperature increase or of a variable which represents the temperature increase is therefore desirable. In this case, the detection may take place in particular by means of sensors and/or circuits which are connected to the battery management system (BMS) mentioned.

For example, U.S. Pat. No. 9,490,507 B1 describes a battery system in which temperature sensors transmit the temperature detected at the cell level to the battery management system, for example by means of RFID. In the case of a temperature increase corresponding to a runaway, the battery management system may, for example, prematurely introduce a coolant from a reservoir into a microchannel of a cell, at the opposite end of which the emergency venting with the burst disk is situated. The flammable electrolyte mixture is diluted therein with the coolant before it emerges from the vent opening which is released by the burst disk at the overpressure.

However, this design has the disadvantage that, for an early detection of the thermal runaway, a temperature sensor has to be arranged in each of the cells of a battery module since, in the case of relatively large intervals (for example, only every second cell is equipped with a temperature sensor), an excessively long time delay may already occur. However, this considerably increases the efforts spent, also with regard to an adaptation of the BMS, and the costs for the monitoring.

Alternatively, the cell voltage may also be monitored in each case by the battery management system if said cell voltage is representative of the thermal cell state. However, provisions are also to be made here in each case at the cell level and, furthermore, the voltage drop may possibly only occur late. In the case of thermal runaway, the delay may be, for example, a few tens of seconds (for example 20 s). However, it should be noted here that the voltage drop may also have different causes than a thermal runaway, for example damage to a contact-making means or a conductor line). For this reason, in this case, for the safe and reliable detection of a thermal runaway, in addition to the voltage, a further variable (such as, for example, the temperature) is additionally to be monitored in order to avoid a false alarm.

Furthermore, pressure sensors which are connected to the battery management system and detect and transmit the pressure in the interior thereof may be provided in the battery pack. Here too, the pressure increase may be representative of the thermal runaway. However, the costs per sensor are considerably higher here than in the case of simple temperature sensors. Furthermore, the pressure increase during runaway is associated with very hot gases, with the result that the requirements placed on the pressure sensors are increased. The situation is similar with sensors which can measure the CO₂ content in the interior of the battery housing.

In EP 3 904 142 A1, it is proposed to attach a temperature sensor to a vehicle-side structure, that is to say outside and at a distance from the battery, specifically in such a way that, after the battery has been attached to the vehicle, said sensor lies opposite a vent opening of the battery, which vent opening is closed by a burst disk. Here, the distance from the vent opening is 5-50 mm. The temperature sensor is connected to the ECU (electronic control unit) of the motor vehicle. One of the advantages is intended to be that, as a result, monitoring by the battery-side battery management system is avoided, which monitoring itself is adversely affected and can fail in the case of a thermal runaway, with the result that fail-safe measures are omitted and the vehicle occupants could not be warned.

Consequently, there is a need for savings in costs and a reduction in the effort for monitoring a possible thermal runaway by the relevant battery management system, while at the same time maintaining or even improving the early detection thereof.

### SUMMARY OF THE INVENTION

Aspects of the invention start from a battery housing for receiving at least one battery module which has a multiplicity of battery cells. The battery housing comprises a housing body, a pressure safety valve and a temperature sensor. The battery housing may be the housing of a battery pack which is used as a traction battery in particular also in electric and hybrid motor vehicles and in vehicles with drives based on fuel cells. The housing body encloses an interior which is configured to receive the battery module. The housing body may be of trough-like and multi-part design with a cover which can be fastened to the trough in the operating state. Aspects of the invention are not restricted to certain geometric embodiments of the housing body. The housing body may also be multi-part. In this case, however, the housing body has a ventilation opening which connects the otherwise preferably closed interior (cavity) to an environment of the housing body. Further openings for cable (power supply, power terminals, communication bus) and pipe feed-throughs (cooling medium) may also be provided. These cable and pipe feed-throughs are permanently sealed in the normal operating state.

Furthermore, a pressure safety valve is provided which is arranged in the vent opening and is configured to close the latter. In this state corresponding to a normal operating state of the battery module, the interior is encapsulated in a gas-tight and liquid-tight manner with respect to the environment by the pressure safety valve. In this case, a negative pressure with respect to the environment may prevail in the interior during operation. The pressure safety valve is now designed to open in the case of a pressure exceeding a threshold value in the interior of the housing body, which corresponds, for example, to a thermal runaway of one of the cells contained in the battery module, and thereby to allow the medium to be expelled from the interior into the environment, but otherwise to maintain the gas-tight and liquid-tight encapsulation.

According to the aspects presented here, it is now proposed to configure a temperature sensor for detecting a temperature of a medium flowing past. In this case, the temperature sensor is arranged on the housing body or the pressure safety valve in or close to the vent opening. By means of this measure, in the case of a thermal runaway, the temperature of the medium can be determined precisely where it is with the greatest probability the hottest, that is to say representative of the process. Namely, the temperature distribution in the battery housing of the battery pack is still very uneven or inhomogeneously distributed at least in the early phase of the runaway and depends greatly on the position of the lined-up battery cell(s) in the module and on the position of the battery module and on the arrangement and packing of the other modules in the battery pack in the housing body. A temperature sensor which is unfavourably placed somewhere in the interior with respect to the location of the relevant cell could also still be surrounded by a bubble of cold medium during the thermal runaway, which bubble cannot escape from the relevant partial region in the housing body.

However, if the case of thermal runaway occurs, the hot medium escapes from the defective battery cell and the internal pressure in the battery housing rises. When a critical internal pressure exceeding the threshold value is reached, the pressure safety valve opens, with the result that the hot medium flows out of the cells through the pressure safety valve or through the released vent opening to the outside into the environment. It should be noted here that this pressure equalization of the venting functions independently of the actual position of the defective cell in the module or of the module in the battery housing. Consequently, the vent opening forms a bottleneck which the hot medium must in any case flow through during the explosion-like expansion. In this way, the condition of an increased temperature can not only be detected comparatively rapidly, for example after only one cell has runaway, but a comparatively objective temperature value can also be obtained despite a still inhomogeneous distribution of the temperatures in the housing body.

As a result, in turn, even just a single temperature sensor in or on the battery pack can be sufficient to detect the thermal runaway. Consequently, the effort for temperature monitoring in the relevant battery management system is considerably reduced, space is saved in the modules and costs are saved overall in a very considerable manner if it is taken into account that, when temperature sensors are used at the cell level instead, each cell would have to be provided with a sensor in order to achieve a comparably safe and rapid detection of a thermal runaway. However, the aspects presented here in principle do not rule out temperature sensors still being used in the battery housing, in the modules or in the cells for various reasons, for example for determining temperatures for the control of the regular normal operation by the battery management system.

It should also be noted that, on account of the positioning of the temperature sensor in or close to the vent opening which is closed by a pressure safety valve, a combination of a temperature sensor and a pressure sensor is implicitly formed to some extent. A hot medium only reaches the temperature sensor rapidly when the pressure safety valve opens. As long as the pressure safety valve is still closed, a temperature-increased medium only reaches the temperature sensor comparatively slowly, for example as a result of thermal conduction and/or diffusion, owing to a lack of dynamic processes in the interior. While therefore the significance of the temperature conditions in the interior of the battery is limited up to the actual opening of the valve, in contrast, in the case of the opening of the valve, a rapid, reliable and relatively precise detection of a runaway is present. In order to obtain information about the conditions upstream of the opening of the valve, the combination with a further sensor, in particular with a pressure sensor, may be very advantageous.

The term “medium” used in this document should be understood here to mean that it comprises cold or hot gases which, however, can also carry original constituents of the cell and chemical reaction products therein, as may occur in particular during thermal runaway. During the explosion-like emergence from the cell, the expanding gases may entrain solid particles, but also liquid droplets, and form corresponding mixtures.

The battery housing or the housing body may be formed from an in particular temperature-resistant and mechanically stable metal or plastic or another material such as, for example, ceramic or a combination thereof. As described in the introductory part, the battery housing or the housing body may be configured, for example by means of subdivisions and fastening devices, to receive, in addition to the battery modules, for example also a cooling system, the battery management system and a high-voltage module and wiring (cables). As mentioned, the battery housing serves to protect the devices received therein from external influences (dirt, vibrations, moisture, high temperatures and pressure) and to create and maintain favorable conditions for the operation of the battery modules. In order to achieve this purpose, the battery housing seals the interior substantially hermetically in the normal operating state, wherein a pressure equalization or a forced venting can be brought about merely by means of the pressure safety valve.

No restriction is provided for the type and type of the temperature sensor. Hot or PTC thermistors in which the electrical resistance changes with the temperature may be considered, for example. The current flowing through the temperature sensor in this case represents a measure of temperature, with the result that the current measurement, preferably by means of the battery management system or a circuit connected thereto, simultaneously represents a temperature detection. The same also applies to the following sensor types: the sensor supplies a signal which represents the temperature and which per se represents a detection of the temperature. A specific numerical value may be calculated in the connected battery management system. The temperature sensors preferably have a wide detection range up to very high temperatures above 100° C., 200° C. or even 500° C., as is the case, for example, in the case of platinum measurement resistors. Alternatively, semiconductor temperature sensors, pyrometers and infrared temperature sensors, heat sensors (vibrating quartz) or thermocouples etc. may be used.

According to a preferred embodiment, the temperature sensor is configured to detect a temperature of a medium flowing past with a delay of 5 s or less. As a result, a particularly fast detection is made possible, with the result that fail-safe measures can be initiated in a timely manner and/or vehicle occupants etc. can be warned early. An NTC sensor (negative temperature coefficient) may be used, for example, as sensor. An NTC sensor may have a negative temperature coefficient, with the result that it conducts the electrical current better at high temperatures than at low temperatures (also referred to as hot thermistors). However, other sensor types may likewise be used, preferably if they offer a similarly low delay in the detection as NTC sensors. Furthermore, it is preferred for this purpose to encapsulate the sensor only to a small extent or comparatively thinly.

According to an advantageous aspect, the pressure safety valve comprises a burst disk. Burst disks are devices known as such for the explosion-like venting. As is also provided in an embodiment proposed herein, they are often understood to mean single-use valves which are destroyed in the event of an explosion-like venting. In this case, it may be a disk or diaphragm which is attached separately to the housing body and covers the vent opening and which may have a predetermined breaking point, for example in the form of a notch or a material thinning which, during use, gives in to a predetermined pressure exerted on the disk from the housing interior. In this case, however, it may likewise be configured as a specifically thinned section in the wall of the housing body itself, which means that the burst disk is formed in one piece with the housing body.

Alternatively, throughout the present disclosure and also in general practice in the art, the term burst disk is understood to mean, for example, a spring-mounted valve disk which can open with regard to the underlying valve opening, but may also close again, that is to say does not “burst” in the narrower sense. Consequently, neither the valve nor the burst disk are necessarily destroyed in the case of venting. In this case, the pressure safety element may be fitted into the vent opening, which thus provides a valve seat. The valve seat may be provided as the surface surrounding the vent opening. A spring element presses (or pulls) the burst disk against the valve seat in the normal operating state. Furthermore, a support element is generally provided which either holds the burst disk firmly on the spring element or mounts the spring element on the housing body etc. The burst disk may be produced, for example, from a partially crystalline thermoplastic high-performance construction material based on polyphthalamide (PPA), as a result of which it is temperature-resistant and robust (high stiffness and strength). The embodiment of the burst disk as a valve which can be closed again by spring action is particularly preferred.

A particularly preferred exemplary embodiment now provides that the temperature sensor is attached to the burst disk or is integrated therein. The temperature sensor is preferably arranged on the inner side of the burst disk, i.e. on that side of the burst disk which faces the interior. In the case of the embodiment of the valve which can be closed again, in which the burst disk lifts up from the outer surface of the housing body, which outer surface surrounds the vent opening, during the venting and opens up a narrow venting channel between the outer surface and the disk edge, a strong volume flow of the emerging hot medium is produced, which volume flow is uniform over a small time frame and thus effectively flows around the temperature sensor over this time frame in the case of thermal runaway and thus permits a sufficiently rapid and precise temperature detection.

Consequently, the embodiment provides that the temperature sensor is attached to or integrated on a surface of the burst disk which faces the interior or else on a part of the pressure safety valve, in particular a spring element or a support element, which part is positioned in the interior.

An alternative embodiment provides that the temperature sensor is attached to an inner wall which faces the interior at a distance from the vent opening, wherein the distance is 50 mm or less. Here too, the advantage is achieved that the hot media which escape from the vent opening flow close to the temperature sensor, with the result that the above-described effects can also be achieved here. The distance of 50 mm ensures that the temperature sensor is close enough to the volume flow of the emerging hot medium.

A further alternative embodiment provides that the temperature sensor is attached to an outer wall which faces the surroundings of the housing body at a distance from the vent opening, wherein the distance is 50 mm or less here too.

According to a further aspect of the battery housing proposed herein, the vent opening and the pressure safety valve may be covered towards the surroundings of the housing body by a protective cover which is attached to an outer wall of the housing body and is permeable to escaping gas. Here, the temperature sensor may advantageously be attached to an inner side of the protective cover, or to a region of the outer surface of the housing body which is also covered by the protective cover. One purpose of such a protective cover is to protect the pressure safety valve from mechanical damage or contamination and to direct the emerging medium in a predetermined direction. At the same time, however, the protective cover also still offers a region which is delimited to some extent and in which the emerging hot medium is not yet diluted by the surrounding air. As a result, under the protective cover, the temperature is still sufficiently high to be detected by the temperature sensor.

A further aspect relates to a battery system which comprises the battery housing described above in various embodiments and aspects. The battery system may be a battery pack. It may furthermore comprise at least one battery module which is received in the battery housing and has a multiplicity of battery cells, and a battery management system for monitoring and regulating and for protecting the battery cells of the at least one battery module. Further devices (cooling system etc.) which are described above, inter alia, may likewise be received in the battery housing. The temperature sensor is connected to the battery management system by means of a signal line in order to transmit such signals which represent the temperature. The signal line may also be configured wirelessly. In this case, the battery management system is configured to output a warning signal which indicates a thermal runaway in one of the battery cells as a function of the signals which represent the temperature. The above-described advantageous effects and functions are achieved with the battery system described according to this aspect.

In this case, the battery management system may furthermore carry out the tasks which are conventionally assigned to it, namely, for example, a state of charge determination, a deep discharge protection, an overcharge protection, the further temperature and/or pressure control, a voltage diagnosis, or a charge and discharge control including balancing etc. The balancing ensures an equalization in the case of differing states of charge of the individual battery cells.

Further advantages, features and details of the various aspects emerge from the claims, the following description of preferred embodiments and with reference to the drawings. In the figures, identical reference signs denote identical features and functions.

### BRIEF DESCRIPTION OF THE DRAWINGS

In the drawings:

FIG. 1 is a schematic perspective view of an overview of a battery system in which an exemplary embodiment is implemented;

FIG. 2 is a partial schematic cross-sectional view of a pressure safety valve with an integrated burst disk according to an exemplary embodiment;

FIG. 3 is an enlarged partial cross-sectional view through the assembled first inner housing part with details of the fixing of the cover portion on the base portion, from the perspective of an end face;

FIG. 4 same as FIG. 3, but with alternative arrangements for the temperature sensor according to modified exemplary embodiments.

### DETAILED DESCRIPTION OF PREFERRED EMBODIMENTS OF THE INVENTION

In the following description of preferred exemplary embodiments, it is to be taken into account that the present disclosure of the various aspects is not restricted to the details of the construction and the arrangement of the components as illustrated in the following description and in the figures. The exemplary embodiments may be put into practice or carried out in various ways. Furthermore, it is to be taken into account that the phraseology and terminology used herein are used only for the purpose of the specific description and should not be interpreted by those skilled in the art as such in a limiting manner. Furthermore, in the following description, identical reference signs in the various exemplary embodiments or figures denote identical or similar features or objects, with the result that in some cases a repeated detailed description thereof is dispensed with in order to preserve the compactness and clarity of the illustration.

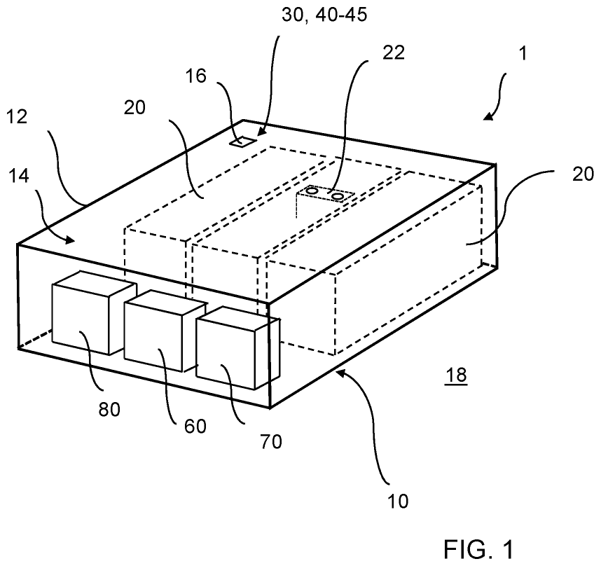

FIG. 1 shows a schematic perspective view of an overview of a battery system or battery pack 1 in which an exemplary embodiment of a battery housing with a vent opening 16 and a temperature sensor 40 which is positioned at the same is implemented.

The battery pack 1 comprises, for example, a substantially cuboidal battery housing 10 which receives the components which are required for a traction battery. The battery housing 10 comprises a housing body 12 which may be composed of a box-shaped base portion and a cover which is fastened thereto. The housing body 12 has an interior 14 in which a number of battery modules 20 are received, of which only 3 are shown here purely by way of example. Furthermore, a battery management system 60, a high-voltage module 70 and a cooling system 80 are received in the interior 14. In the simplified illustration of FIG. 1, further components of the cooling system 80 such as, for example, cooling plates, lines for circulating the cooling fluid and external connection ports are omitted. Likewise, in the illustration, the cabling between the battery modules 20 and the high-voltage module 70 on the one hand (charging or discharging current) and the battery modules 20 and the battery management system 60 on the other hand (inter alia control and sensor system) and the corresponding external connections, in particular a communication connection between the battery management system 60 and an (external) ECU of the motor vehicle (not shown), are omitted.

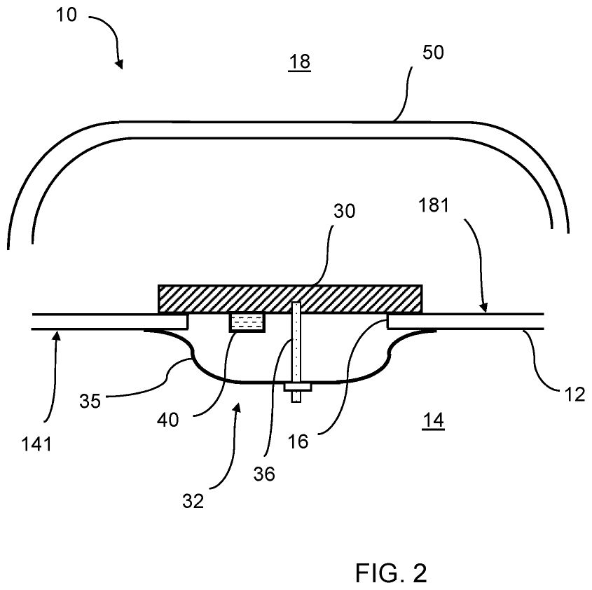

The housing body 12 may be produced from a plastic or a metal or another heat-resistant material with, for example, high stiffness and strength. In the exemplary embodiment, a vent opening 16 is formed in the thin wall of the housing body 12 on the upper side, or herein especially in the cover. The shape of the vent opening 16 is arbitrary, for example round, square, rectangular, IDC. In the state ready for operation, the vent opening 16 represents the substantially single connection between the interior 14 and an environment 18 of the battery housing 10 as far as a pressure safety valve 30 (see FIGS. 2-4) which is formed in the vent opening 16 is open. An emergency or forced venting of the interior 14 can take place via the pressure safety valve 30 in the vent opening 16 when a critical overpressure is reached. The critical overpressure is reached during the thermal runaway by one or more of a multiplicity of battery cells 22 which are combined in a stacked manner in the battery modules and of which a single battery cell is drawn schematically in FIG. 1. The battery cells 22 may be of any desired type, for example prismatic (as illustrated schematically) or cylindrical.

FIG. 2 shows an enlarged cross-sectional view of a pressure safety valve 30 in a vent opening 16 of the housing body 12 of the battery housing 10 according to the present exemplary embodiment in relatively large detail, wherein this illustration is also purely schematic. The vent opening 16 is formed in a thin wall of the housing body 12, wherein an inner wall 141 faces the interior 14 of the housing body 12, and an outer wall 181 faces the environment 18 of the battery housing 10. The pressure safety valve 30 comprises a burst disk 32, a spring element 35 and a support element 36. The burst disk 30 covers the vent opening 16 from the outside and therefore closes the interior 14 in a gas-tight and liquid-tight manner in the normal operating state. The spring element 35 exerts a tensile force directed in the direction of the interior 14 on the burst disk 32, with the result that the latter is pressed against the outer surface of the housing body 12 which surrounds the vent opening 16. This outer surface therefore forms a type of valve seat. The support element 36 transfers this tensile force to the burst disk 32 and holds the burst disk 32 in position. It should be noted that completely different designs and constructions for the pressure safety valve 30 are also possible and that the spring element 35 may also be provided, for example, by a helical spring or, for example, a heat-resistant elastic plastic.

A temperature sensor 40 is arranged on that inner side surface of the burst disk 32 which is directed towards the interior 14, which temperature sensor may be selected as desired from one of the abovementioned or other types. The temperature sensor 40 may also be fastened to the burst disk 32 in any desired manner. For example, it may be adhesively bonded, fastened with mechanical aids or received in a form-fitting manner in a recess in the surface of the burst disk 32. Combinations thereof are also possible. On account of this arrangement, the temperature sensor 40 is situated more or less exactly in the vent opening 16. The vent opening 16 has, for example, a diameter of 50 mm. The burst disk 32 has, for example, a diameter of 56 mm.

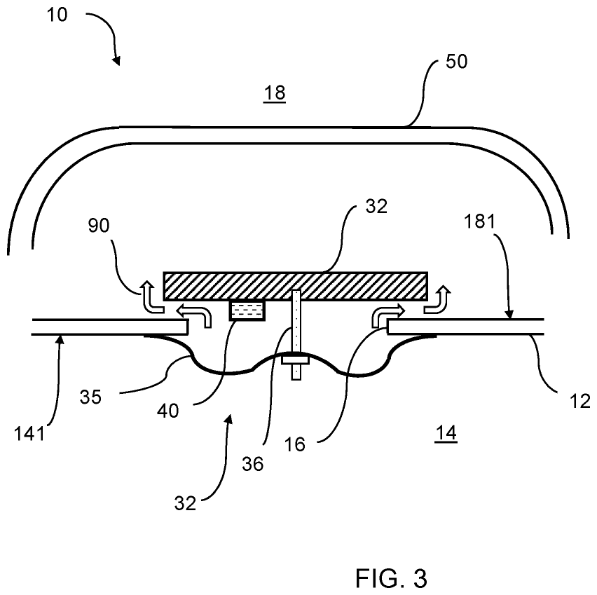

FIG. 3 shows a state of the forced or emergency venting for the same exemplary embodiment. This may be a thermal runaway in which a hot medium 90 (indicated by arrow), for example a mixture of gaseous products of a chemical reaction in the battery cells, combustion products, and entrained liquid substances or particles, escapes from the interior 14 via the pressure safety valve 30 into the environment 18 when the critical overpressure is reached. The critical pressure at which the pressure safety valve 30 opens is determined substantially by the structure and the material of the spring element 35 and the cross section of the vent opening 16. It is set in such a way that a thermal runaway can be detected early. A purely exemplary value for the critical pressure which in no way limits the protective range may be 75 mbar.

If the critical pressure is reached, the burst disk 32 lifts up from the outer surface of the housing body 12, which outer surface surrounds the vent opening 16, against the clamping force of the spring element 35 and thereby all around releases a gap for the escaping medium 90. As a result of the expansion of the hot gases in the medium 90, remaining cool gas constituents are rapidly pressed out in the region in front of the vent opening 16, with the result that the temperature sensor 40 is flowed around by the hot medium after a very short time. As a result, a rise in the temperature, which information can be transmitted to the battery management system 60 by means of a signal line (not shown), may be detected very rapidly by the temperature sensor 40 by suitable selection of the type with a delay of 5 seconds or less. The signal line may also comprise wireless sections (for example RFID or NFC). The battery management system 60 may in turn output a warning signal (for example also to the ECU of the vehicle), on account of which warning signal, for example fail-safe measures are initiated against the risk of fire or the vehicle occupants are warned.

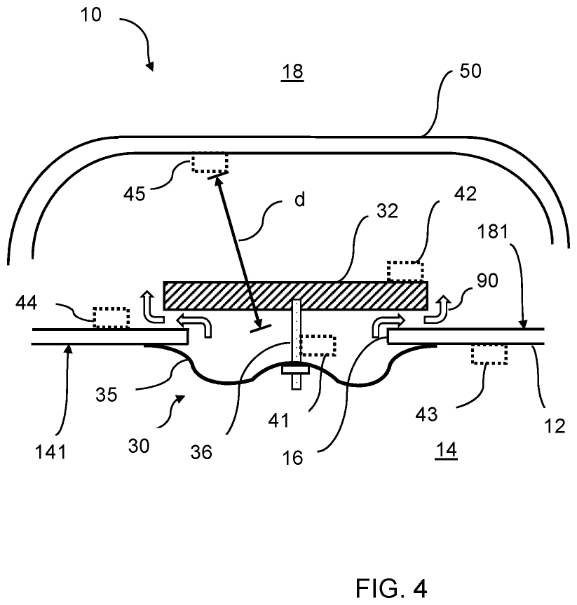

Modifications of the exemplary embodiment shown in FIG. 2 or 3 are illustrated with reference to FIG. 4. The modifications relate to different positionings of the temperature sensor, denoted here by the reference signs 41 to 45. Although drawn in the same figure, a cumulative arrangement of actually 5 sensors is herein not intended, although not ruled out.

Thus, for example, instead of being attached to the burst disk 32, a temperature sensor 41 may rather be attached to the support element 36 or to the spring element 35. Furthermore, it is also possible to attach the temperature sensor 42 to the outer side surface of the burst disk 32 which is directed towards the environment 18, or to integrate said temperature sensor at that position in the burst disk. According to other modifications, the temperature sensor is not attached to the pressure safety valve 30 itself, but rather to the housing body 12, as can be seen with regard to the temperature sensors 43 (on the inner wall 141) or 44 (on the outer wall 181).

A further modification relates to the attachment of a temperature sensor 45 to a protective cover 50 which covers the vent opening 16 from the outside, in order to protect said vent opening per se from damage and contamination. The protective cover 50 creates a space which is not tight but delimited above the vent opening 16 and in which the emerging hot medium 90 collects before the further emergence, with the result that here too, a sudden temperature change which is characteristic of the thermal runaway can be detected reliably and in a short time. A property common to all of the temperature sensors 40-45 proposed here is that the distance d from the temperature sensor to the vent opening 16 amounts, for example, to 50 mm or less. This distance ensures a reliable detection of the temperature changes. However, depending on the size, the design and the arrangement of the battery pack, this distance d may also be greater (for example 100 mm or less) or smaller (for example 40 mm or less or even 30 mm or less).

The statements and details which are provided in the specific exemplary embodiments should not be interpreted in a restrictive manner with regard to the scope of protection which is stipulated in the appended claims. Thus, further modifications are also possible. For example, the vent opening 16 which is described in the above exemplary embodiments as an opening which is formed in a thin housing wall may also be designed as an elongate channel which extends through the housing body 12 and possibly protrudes internally or externally. In this case, the temperature sensor 40 may advantageously be placed at any desired point in the channel or on the channel wall. In this case, the pressure safety valve 30 may be formed at the inlet or at the outlet or centrally in the channel.

Furthermore, it has been described above that the burst disk 32 of the pressure safety valve 30 lifts up from the surface surrounding the vent opening 16 against the clamping force of the spring element 35 in the case of the forced or emergency venting. However, in this case—as the thermal runaway progresses—it may occur that the overpressure in the interior 14 of the battery housing 10 becomes so great that the integrity of the pressure safety valve 30 can no longer be maintained, and individual parts of the pressure safety valve 30 break out or burst, for example also the burst disk 32. However, this does not adversely affect the fact that the characteristic temperature changes could already be effectively detected beforehand by the temperature sensor 40 and the effects which are sought according to the invention are thereby achieved.

### LIST OF REFERENCE NUMERALS

1 Battery system, battery pack
10 Battery housing
12 Housing body
14 Interior
16 Vent opening
18 Environment
20 Battery module
22 Battery cell
30 Pressure safety valve
32 Burst disk
35 Spring element
40 Temperature sensor, integrated in burst disk, at inner side
41 Temperature sensor, on the support or spring element
42 Temperature sensor, integrated in burst disk, at outer side
43 Temperature sensor, on inner wall
44 Temperature sensor, on outer wall
45 Temperature sensor, on protective cover
50 Protective cover
60 Battery management system
70 High-voltage module
80 Cooling system
90 medium
141 inner wall
181 outer wall
d distance from the vent opening

1. A battery housing for receiving at least one battery module which has a multiplicity of battery cells, comprising:
a housing body which encloses an interior which is configured to receive the battery module, wherein the housing body has a vent opening which connects the interior to an environment of the housing body;
a pressure safety valve which is arranged in the vent opening and is configured to close the vent opening, so that the interior is encapsulated in a gas-tight and liquid-tight manner with respect to the environment by the pressure safety valve in a normal operating state of the battery module, wherein the pressure safety valve is designed to open in the case of a pressure exceeding a threshold value in the interior of the housing body and thereby to allow a medium to be expelled from the interior into the environment; and
a temperature sensor for detecting a temperature of the medium flowing past, wherein the temperature sensor is arranged at least one of: on the housing body, on the pressure safety valve, in the vent opening, and close to the vent opening.

2. The battery housing according to claim 1, wherein the pressure safety valve comprises a burst disk.

3. The battery housing according to claim 2, wherein
the temperature sensor is attached to the burst disk.

4. The battery housing according to claim 2, wherein the temperature sensor is attached to a surface of the burst disk which faces the interior.

5. The battery housing according to claim 4, wherein
the burst disk forms a valve which can be closed again by spring action.

6. The battery housing according to claim 3, wherein
the burst disk forms a single-use valve in which the burst disk tears or bursts as a result of a pressure exceeding the threshold value in the interior of the housing body.

7. The battery housing according to claim 3, wherein
the temperature sensor is attached to an inner wall which faces the interior at a distance from the vent opening, wherein the distance is 50 mm or less.

8. The battery housing according to claim 3, wherein
the temperature sensor is attached to an outer wall which faces the environment of the housing body at a distance from the vent opening, wherein the distance is 50 mm or less.

9. The battery housing according to claim 3, wherein
the vent opening and the pressure safety valve are covered towards the environment of the housing body by a protective cover which is attached to an outer wall of the housing body and is permeable to escaping gas, wherein the temperature sensor is attached to an inner side of the protective cover.

10. The battery housing according to claim 3, wherein
the temperature sensor detects a temperature of a gas flowing past with a delay of 5 s or less.

11. The battery housing according to claim 3, wherein
the temperature sensor is an NTC sensor.

12. A battery system, comprising:
the battery housing;
at least one battery module which is received in the battery housing and has a multiplicity of battery cells;
a battery management system for monitoring and regulating and for protecting the battery cells of the at least one battery module;
wherein the temperature sensor is connected to the battery management system by means of a signal line in order to transmit such signals which represent the temperature;
wherein the battery management system is configured to output a warning signal which indicates a thermal runaway in one of the battery cells as a function of the signals which represent the temperature.

13. The battery system of claim 12, wherein the battery housing comprises:
a housing body which encloses an interior which is configured to receive the battery module, wherein the housing body has a vent opening which connects the interior to an environment of the housing body;
a pressure safety valve which is arranged in the vent opening and is configured to close the vent opening, so that the interior is encapsulated in a gas-tight and liquid-tight manner with respect to the environment by the pressure safety valve in a normal operating state of the battery module, wherein the pressure safety valve is designed to open in the case of a pressure exceeding a threshold value in the interior of the housing body and thereby to allow a medium to be expelled from the interior into the environment; and
a temperature sensor for detecting a temperature of the medium flowing past, wherein the temperature sensor is arranged at least one of: on the housing body, on the pressure safety valve, in the vent opening, and close to the vent opening.

14. The battery housing according to claim 3, wherein
the temperature sensor is attached to a part of the pressure safety valve.

15. The battery housing according to claim 14, wherein
the part of the pressure safety valve is at least one of: a spring element and a support element.

16. The battery housing according to claim 14, wherein
the part of the pressure safety valve is positioned in the interior.
